(19) United States
(12) Patent Application Publication
(10) Pub. No.: US 2014/0030428 A1
(43) Pub. Date: Jan. 30, 2014

(54) GLUE DISPENSING DEVICE AND GLUE DISPENSING METHOD

(71) Applicant: HON HAI PRECISION INDUSTRY CO., LTD., New Taipei (TW)

(72) Inventor: CHIEN-CHUN WANG, New Taipei (TW)

(73) Assignee: HON HAI PRECISION INDUSTRY CO., LTD., New Taipei (TW)

(21) Appl. No.: 13/717,729

(22) Filed: Dec. 18, 2012

(30) Foreign Application Priority Data
Jul. 30, 2012 (TW) 101127522

(51) Int. Cl. B05C 1/00

(52) U.S. Cl. CPC B05C 1/00
USPC 427/162; 401/209; 401/215

(57) ABSTRACT

A glue dispensing device includes a glue tube and a ball. The glue tube includes a taped glue outflow end. The glue outflow end defines a round opening. The ball is movably received in the glue tube, a diameter of the ball is greater than a diameter of the round opening. The ball closes the round opening when not being pressed, and opens the round opening when being pressed.

### BACKGROUND

1. Technical Field

The present disclosure relates to a glue dispensing device and a glue dispensing method using the glue dispensing device.

2. Description of Related Art

During a lens module assembly process, glue is required to fix an optical element firmly in a barrel. Small needles are generally employed to inject and dispense the glue as the lens module becomes more compact. However, the glue may drip from the small needles when not in use and may contaminate the lens module.

Therefore, it is desired to provide a glue device and a glue method which can overcome the above mentioned shortcomings.

### BRIEF DESCRIPTION OF THE DRAWINGS

FIG. 1 is a schematic, isometric view of a glue dispensing device according to a first embodiment.

FIG. 2 is an enlarged, sectional, partial view of the glue dispensing device of FIG. 1.

FIG. 3 is a schematic view showing a glue dispensing method according to a second embodiment.

FIG. 4 is another schematic view showing the glue dispensing method according to the second embodiment.

FIG. 5 is an enlarged view of a circled part V of FIG. 4.

FIG. 6 is a schematic view showing a glue dispensing method according to a third embodiment.

### DETAILED DESCRIPTION

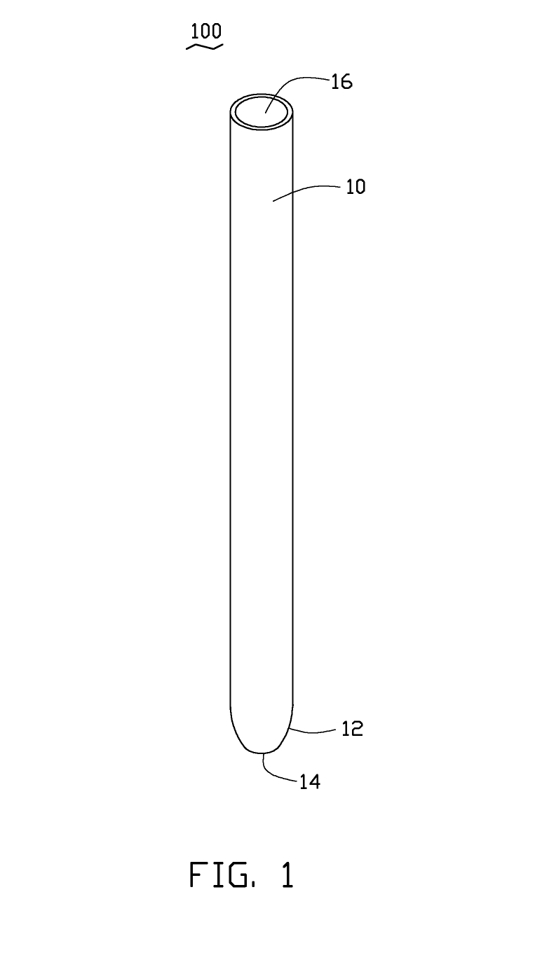

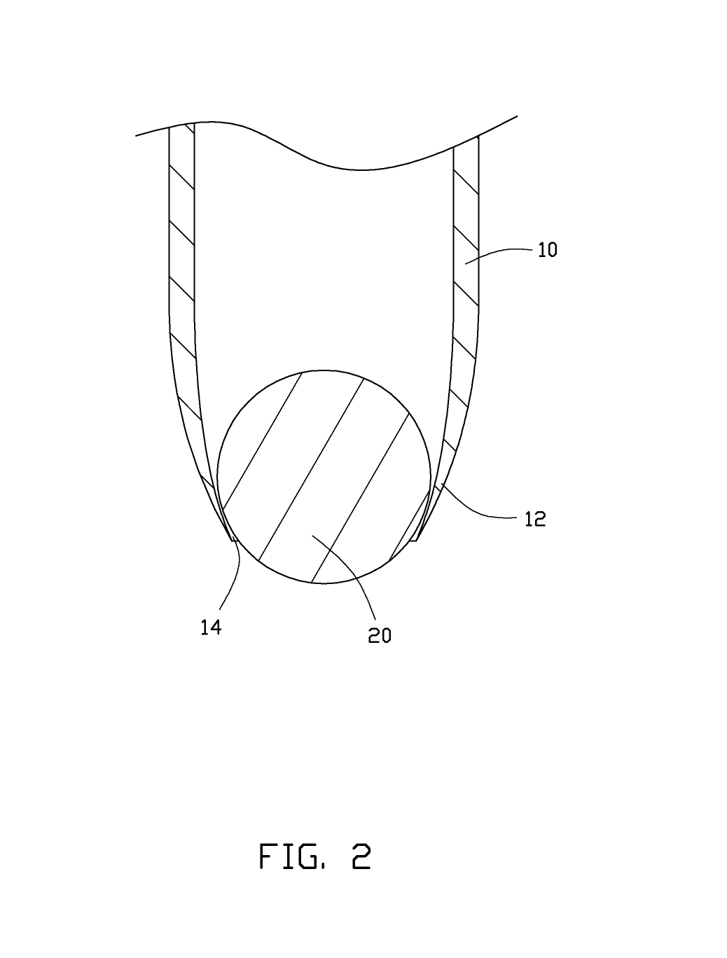

FIGS. 1 and 2 show a glue dispensing device 100 according to a first embodiment. The glue dispensing device 100 includes a glue tube 10 and a ball 20. The glue tube 10 includes a glue outflow end 12 and a glue inflow end 16 opposite to the glue outflow end 12. The glue outflow end 12 is a taped end and defines a round opening 14. The ball 20 is movably contained in the glue tube 10 at the glue outflow end 12. A diameter of the ball 20 is greater than a diameter of the round opening 14. The ball 20 closes the round opening 14. The round opening 14 can be opened by pushing the ball 20 into the glue tube 10. The glue inflow end 16 is used for injecting glue into the glue tube 10. The diameter of the ball 20 is smaller than a diameter of the glue inflow end 16. In this embodiment, the ball 20 is made of metal.

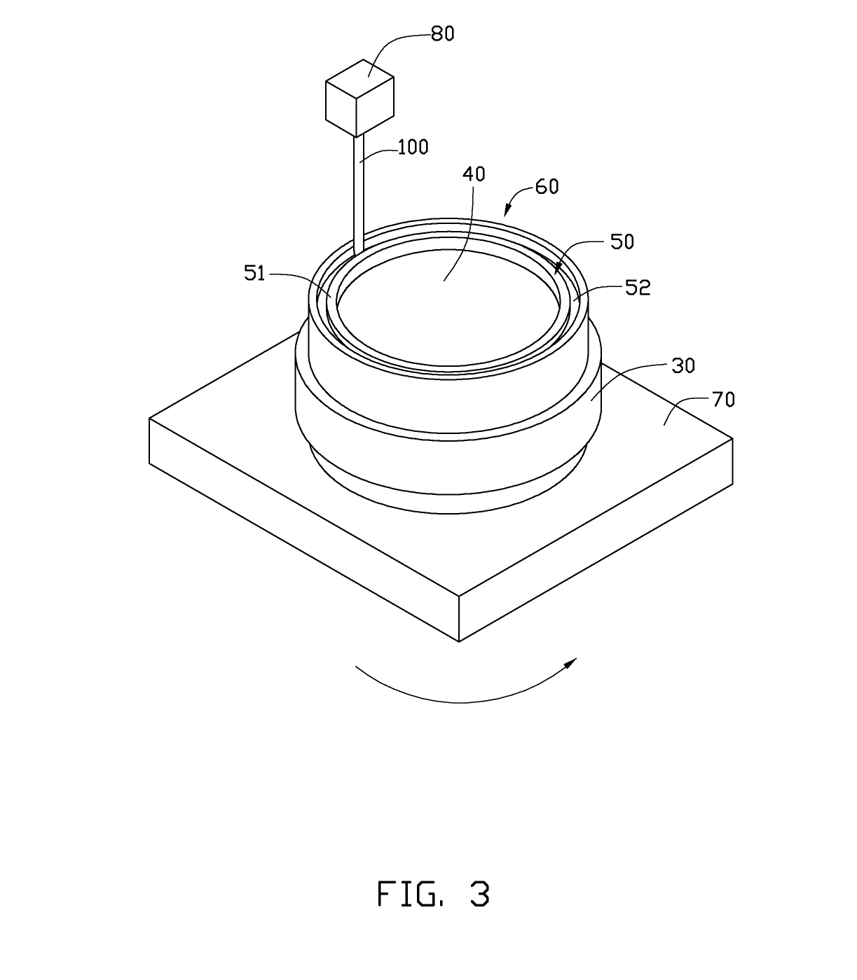

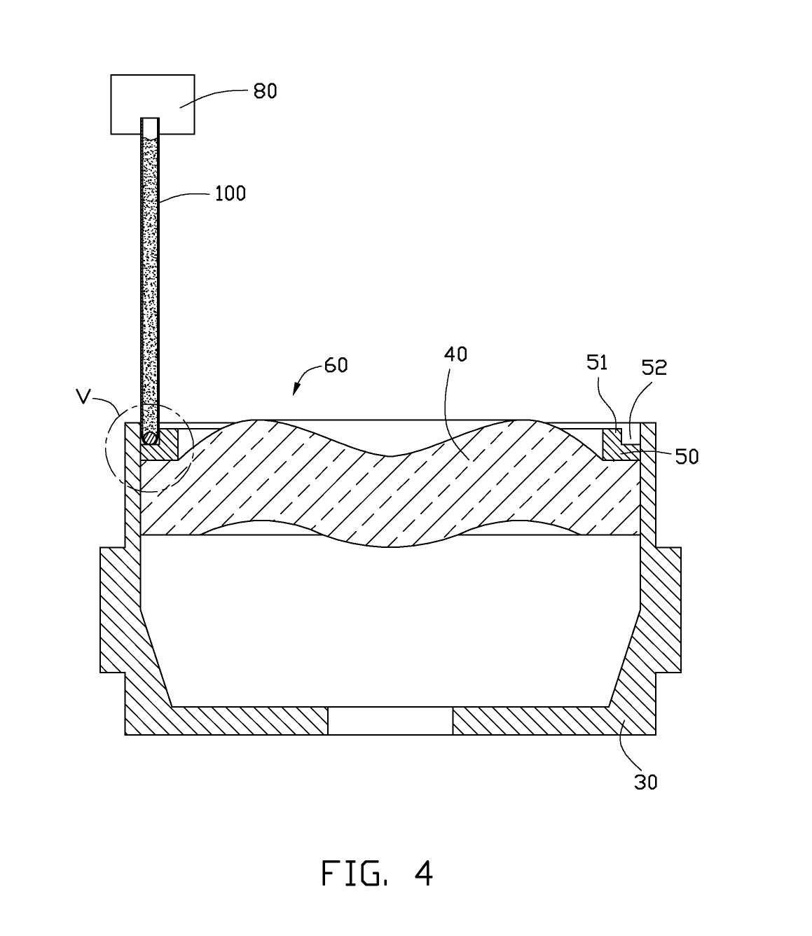

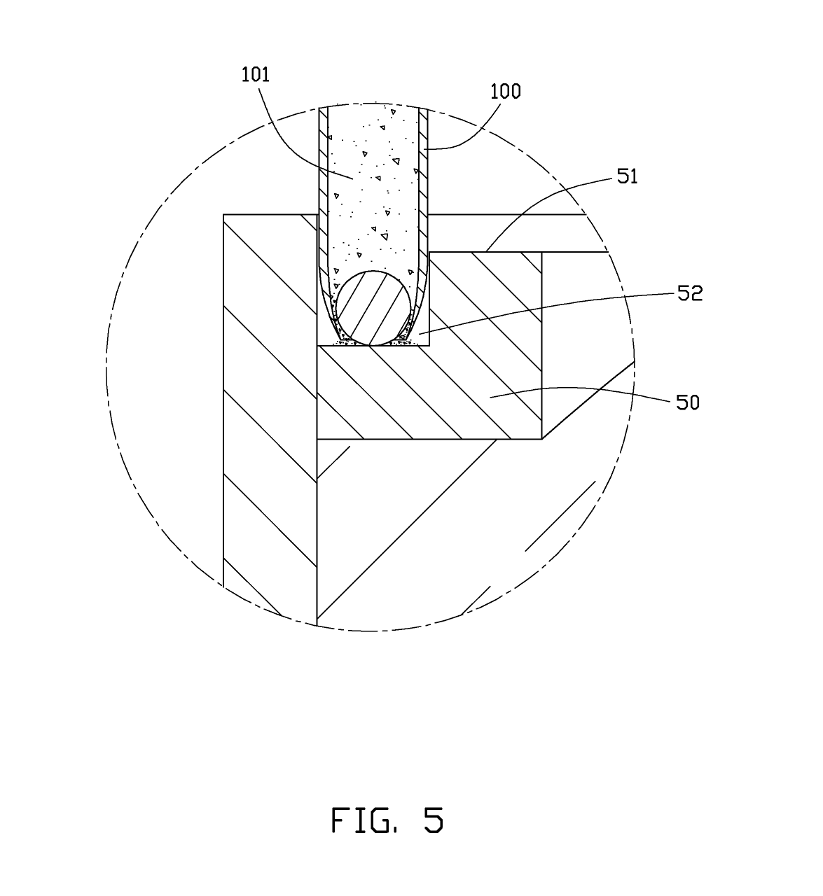

FIGS. 3 to 5 show a glue dispensing method using the glue dispensing device 100 accordingly to a second embodiment. The glue dispensing method includes steps described below.

In step 1, a unfinished lens module 60 including a barrel 30, a lens 40 and a spacer 50 is provided. The lens 40 and the spacer 50 are received in the barrel 30. The spacer 50 can be a spacer ring or a filter. The spacer 50 includes a ring shaped projection 51 spaced from the barrel 30. The spacer 50 and the barrel 30 cooperatively form a glue receiving groove 52.

In step 2, a rotary platform 70 is provided to carry the lens module 60.

In step 3, the glue dispensing device 100 is provided. The glue dispensing device 100 receives glue 101 in the glue tube 10 and is fixed on a robotic arm 80.

In step 4, the glue dispensing device 100 is driven by the robotic arm 80 to make the glue outflow end 12 enter into the glue receiving groove 52. The bottom surface of the glue receiving groove 52 pushes the ball 20 to open the round opening 14. The glue 101 flows into the glue receiving groove 52 from the round opening 14. The rotary platform 70 drives the lens module 60 to rotate. In this way, the glue 101 is applied to the whole glue receiving groove 52.

In step 5, the glue dispensing device 100 is driven by the robotic arm 80 to make the glue outflow end 12 move out of the glue receiving groove 52 and the ball 20 close the round opening 14.

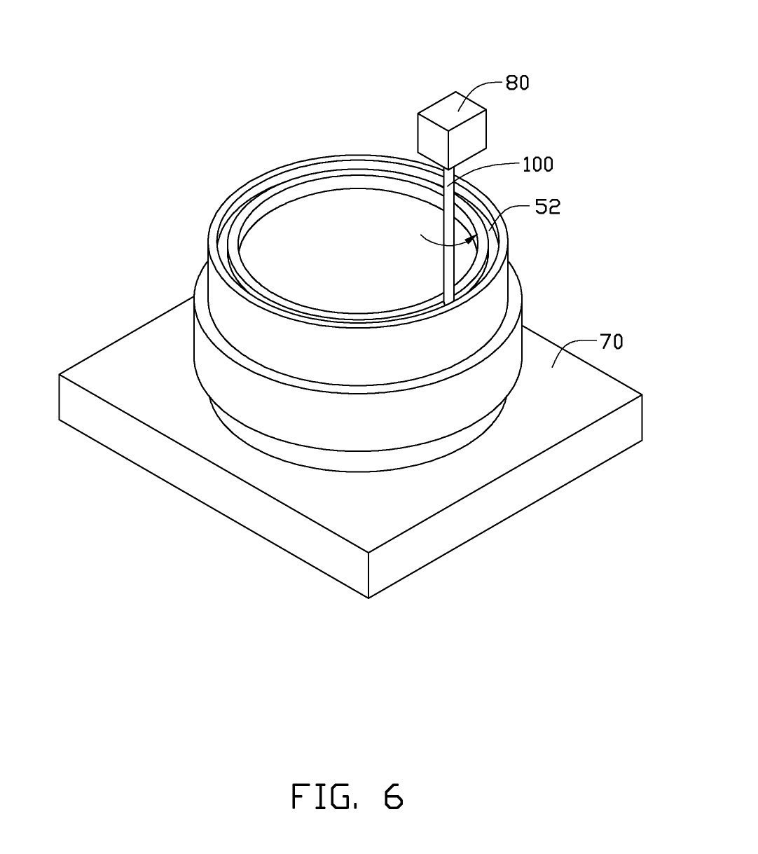

FIG. 6 shows a glue dispensing method according to a third embodiment. The glue dispensing method of the third embodiment is similar to the glue dispensing method of the second embodiment, except that when the glue 101 flows into the glue receiving groove 52, the lens module 60 is stable, and the robotic arm 80 drives the glue dispensing device 100 to rotate around a center of the glue receiving groove 52.

The glue dispensing device 100 uses a ball 20 to close the round opening 14, thus, the glue 101 will not drip from the glue tube 10 when not in use.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A glue dispensing device, comprising:
a glue tube comprising a taped glue outflow end, the glue outflow end defining a round opening; and
a ball movably received in the glue tube, a diameter of the ball being greater than a diameter of the round opening; wherein
the ball closes the round opening when not being pressed, and opens the round opening when being pressed.

2. The glue dispensing device of claim 1, wherein the glue tube comprises a glue inflow end opposite to the glue outflow end, the glue inflow end is configured for injecting glue into the glue tube.

3. The glue dispensing device of claim 2, wherein the diameter of the ball is smaller than a diameter of the glue inflow end.

4. The glue dispensing device of claim 1, wherein the ball is made of metal.

5. A glue dispensing method, comprising:
providing a lens module, the lens module comprising a barrel, a lens, and a spacer, wherein the lens and the spacer are received in the barrel, the spacer and the barrel cooperatively form a glue receiving groove;
providing a platform to carry the lens module;
providing a glue dispensing device as claimed in claim 1, the glue tube of the glue dispensing device receiving glue;
moving the glue dispensing device to make the glue outflow end enter into the glue receiving groove, the ball pushed by the spacer to open the round opening, the glue flowing into the glue receiving groove from the round opening; and
moving the glue dispensing device to make the glue outflow end out of the glue receiving groove.

6. The glue dispensing method of claim 5, wherein the spacer is a spacer ring or a filter.

7. The glue dispensing method of claim 5, wherein the platform is a rotary platform, the rotary platform drives the lens module to rotate when the glue flows into the glue receiving groove.

8. The glue dispensing method of claim 5, wherein the glue dispensing device is fixed on a robotic arm, the lens module is stable, and the robotic arm drives the glue dispensing device to rotate when the glue flows into the glue receiving groove.
